(19) United States
(12) Patent Application Publication
(10) Pub. No.: US 2012/0133738 A1
(43) Pub. Date: May 31, 2012

(54) Data Processing System and Method for Providing at Least One Driver Assistance Function

(75) Inventors: Matthias Hoffmeier, Berlin (DE); Kay Talmi, Berlin (DE)

(73) Assignee: HELLA KGAA HUECK & CO., Lippstadt (DE)

(21) Appl. No.: 13/263,225

(22) PCT Filed: Mar. 31, 2010
(86) PCT No.: PCT/EP2010/054381

§ 371 Date: Nov. 21, 2011

(30) Foreign Application Priority Data
Apr. 6, 2009 (DE) 10 2009 016 580.0

(51) Int. Cl. H04N 7/18; H04N 13/02

(52) U.S. Cl. 348/46; 348/148; 348/E07.085; 348/E13.074; 348/E13.004

(57) ABSTRACT

The invention relates to a data processing system and a method for providing at least one driver assistance function. A stationary receiving unit (30a to 30c) for receiving image data receives image data generated by means of an image capturing unit (20) of a vehicle (12) by capturing an image of the surroundings of the vehicle (12). A stationary processing unit (40) processes at least a part of the received image data, wherein the stationary processing unit (40) generates driver assistance data with at least one driver assistance information on the basis of the image data, wherein with the aid of the generated driver assistance information at least one driver assistance function can be generated in the vehicle (12). A sending unit (30a to 30c) sends the driver assistance data to the vehicle (12).

The invention relates to a data processing system and a method for providing at least one driver assistance function. By means of at least one image capturing unit of a vehicle, at least one image of the surroundings of the vehicle is generated. On the basis of the image data, driver assistance information of at least one driver assistance information is generated by which a driver assistance function is provided in the vehicle.

A large number of camera-based driver assistance systems for increasing comfort and driving safety are known for motor vehicles. Such driver assistance systems relate in particular to warning systems which warn the driver of an unintended lane departure (Lane Departure Warning—LDW) or support the driver in keeping the own lane when driving (Lane Keeping Support—LKS). Further, driver assistance systems for the longitudinal vehicle control (ACC), for the light control of the light emitted by the headlights of the vehicle, for traffic sign recognition as well as for meeting traffic regulations specified by the traffic signs, blind spot warning systems, distance measuring systems with forward collision warning function or with braking function as well as braking assistance systems and overtaking assistance systems are known. For image capturing, known driver assistance systems usually use a vehicle camera mounted in or on the vehicle. Advantageously, the cameras are arranged behind the windshield in the area of the interior mirror. Other positions are possible.

Known vehicle cameras are preferably designed as video cameras for capturing several images successively as an image sequence. By means of such a camera, images of a detection area in front of the vehicle with at least an area of the road are captured and image data corresponding to the images are generated. These image data are then processed by means of suitable algorithms for object recognition and object classification as well as for tracking objects over several images. Objects that are classified as relevant objects and are further processed are in particular those objects that are relevant for the respective driver assistance function such as oncoming vehicles and vehicles driving ahead, lane markings, obstacles on the lanes, pedestrians on and/or next to the lanes, traffic signs, traffic light signal systems and street lights.

From the document WO 2008/019907 A1, a method and a device for driver assistance by generating lane information for supporting or replacing lane information of a video-based lane information device are known. A reliability parameter of the determined lane information is ascertained and, in addition, a lane information of at least one further vehicle is determined, which information is transmitted via a vehicle-to-vehicle communication device.

From the document EP 1 016 268 B1, a light control system for a motor vehicle is known. By means of a microprocessor, at least one image is processed to detect headlights of oncoming vehicles and tail lights of vehicles driving ahead and to determine a control signal for the control of the headlights of the vehicle.

From the document WO 2008/068837 A1, a traffic situation display method is known, by which the traffic safety is increased in that the position of a vehicle is displayed in connection with a video sequence.

In the case of camera-based driver assistance systems in vehicles, there is the problem that due to the limited space in the vehicle only relatively small processing processes, i.e. a relatively low computing capacity and a relatively small storage, can be provided for processing the image data and for providing the driver assistance function. Providing more resources in the vehicle means high costs. Only then high-quality driver assistance functions can be provided. As a compromise, the driver assistance functions actually provided can be limited to only a part of the possible driver assistance functions. Further, the algorithms required for processing the image data and for analyzing the image information have to be adapted to specific conditions of the vehicle and of the vehicle surroundings. In the case of systems already established in vehicles, relatively complex software updates have to be carried out for updating.

Likewise, the consideration of country-specific or region-specific characteristics in the processing of the image data for providing some driver assistance functions requires the storage of country-specific data sets in the vehicle. Further, these data sets have to be updated on a regular basis.

It is the object of the invention to specify a data processing system and a method for providing at least one driver assistance function, in which only little resources for providing the driver assistance function in the vehicle are required.

This object is solved by a data processing system having the features of claim 1 as well as by a method according to the independent method claim. Advantageous developments of the invention are specified in the dependent claims.

By transmitting the image data from the vehicle to a stationary processing unit, the processing expense for providing the driver assistance function in the vehicle can be considerably reduced. In addition, when providing the driver assistance function further information coming from the vehicle as well as information not coming from the vehicle can be taken into account easily. Further, the driver assistance functions provided in the vehicle can be extended and restricted easily in that only desired and/or only agreed driver assistance information is transmitted with the aid of the driver assistance data from the stationary processing unit to the vehicle. In particular, simply structured image capturing units, for example simply structured cameras, and simply structured sending units for sending the image data to the stationary receiving unit can be installed in the vehicle. For this, relatively little space is required so that the camera and the sending unit or, respectively, a sending unit for sending the image data and a receiving unit for receiving the driver assistance data occupy only little space in the vehicle, and these components can be installed in a large number of vehicles at relatively small costs. In this way, a position-dependent driver assistance function, in particular the consideration of country-specific characteristics of the country where the vehicle is actually located is easily possible. These country-specific characteristics in particular relate to country-specific traffic signs and/or country-specific traffic guidance systems. Here, the vehicle position can be determined by the vehicle and can be transmitted to the stationary receiving unit, or it can be determined via the position of the stationary receiving unit.

In an advantageous embodiment of the invention, an image capturing system is provided in the vehicle, which captures several images with a respective representation of an area of the surroundings of the vehicle as an image sequence and generates image data corresponding to the representation for each captured image. Further, a vehicle sending unit is provided which sends at least a part of the image data of the images to the stationary receiving unit. The image capturing system in particular generates compressed image data which, for example, have been compressed with the JPEG compression process or a process for MP4 compression. Further, it is possible that only the image data of a detail of the image captured by means of the image capturing system are transmitted to the stationary receiving unit and are processed by the stationary processing unit. In contrast to the components that are arranged in the vehicle and that are also referred to as mobile units or vehicle units due to their arrangement in or, respectively, on the vehicle, the stationary units are, at least during their operation, at a specific geographic location. In particular, during processing of the image data and generating the driver assistance data, the stationary units remain at their respective geographic location.

The image capturing system can in particular capture 10 to 30 images per second and then transmit their image data to the stationary receiving unit. The transmission between the vehicle and a stationary receiving unit located in the transmission range of the vehicle preferably takes place by means of a radio data transmission, for example with known WLAN or mobile radio data transmission links. Alternatively, optical line-of-sight radio links such as laser transmission links can be used.

Further, it is advantageous to provide a vehicle receiving unit which receives the driver assistance data sent by the stationary sending unit. Both the data sent from the vehicle to the stationary receiving unit and the data sent from the stationary sending unit to the vehicle receiving unit are provided with a user identification of the vehicle or, respectively, a vehicle identification to ensure the allocation of these data to the vehicle from which the processed image data come. Further, it is advantageous to provide a processing unit arranged in the vehicle which processes the received driver assistance data and outputs information to the driver via a human-machine interface (HMI). Alternatively or additionally, the processing unit can control at least one vehicle system of the vehicle dependent on the received driver assistance data. This vehicle system can in particular be a light system, a braking system, a steering system, a drive system, a safety system and/or a warning system. As a result thereof, the assistance system can actively intervene in the guidance of the vehicle and, if necessary, prevent dangerous situations or reduce the hazard.

Further, it is advantageous when the stationary processing unit detects and classifies representations of objects in the images during processing of the received image data and generates the driver assistance data dependent on the classified objects. By classifying the representations of objects, a conclusion on the traffic situation and hazards as well as on relevant information can be drawn.

Further, the stationary processing unit can determine the image position of a classified object and/or the relative position of the classified object to the vehicle and/or the position of the classified objet in a vehicle-independent coordinate system, such as the world coordinate system. In this way, the traffic situation can be specified even more and specific hazards can be determined.

Further, it is advantageous when the image capturing system comprises at least one stereo camera. The images of the single cameras of the stereo camera can then be transmitted as image data of an image pair from the vehicle sending unit to the stationary receiving unit and further to the stationary processing unit. The stationary processing unit can then determine the representations of the same objet in the images of each image pair, can determine their image position and, based on these image positions, determine the distance of the object to the stereo camera and thus to the vehicle. As a result thereof, the distance of the vehicle to objects can be determined relatively exactly.

Further, the stationary receiving unit can receive additional data with further information in addition to the image data from the vehicle. This additional information can in particular comprise the current position of the vehicle, the speed of the vehicle, information on the weather conditions at the location of the vehicle, information on the conditions of visibility in the area of the vehicle and information on the settings and/or operating states of the vehicle such as the adjusted light distribution of the headlights of the vehicle, and/or information detected by means of vehicle sensors such as detected lane markings, determined distances to objects, in particular to other vehicles. In this way, much initial information for generating the driver assistance data is available so that the driver assistance information contained in the driver assistance data can be determined correctly with a higher probability and/or can be determined at a relatively low expense.

The method having the features of the independent method claim can be developed in the same manner as specified for the data processing system according to the invention.

Further features and advantages of the invention result from the following description which, in connection with the enclosed Figures, explains the invention in more detail with reference to embodiments.

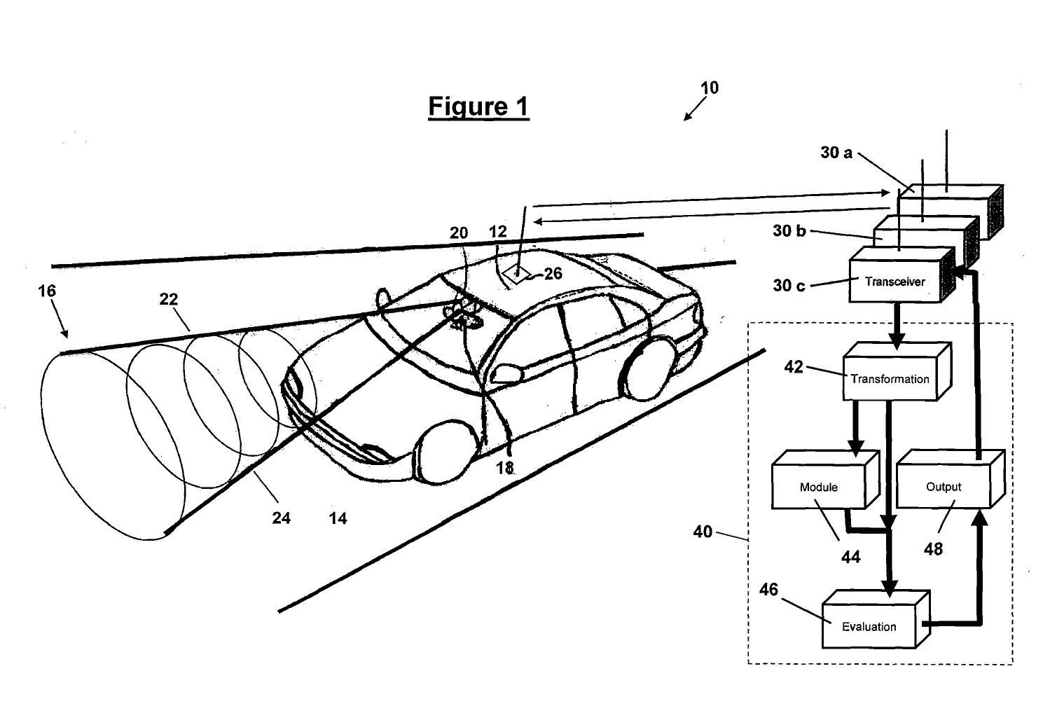

FIG. 1 shows a schematic general view of a driver assistance system according to a first embodiment of the invention.

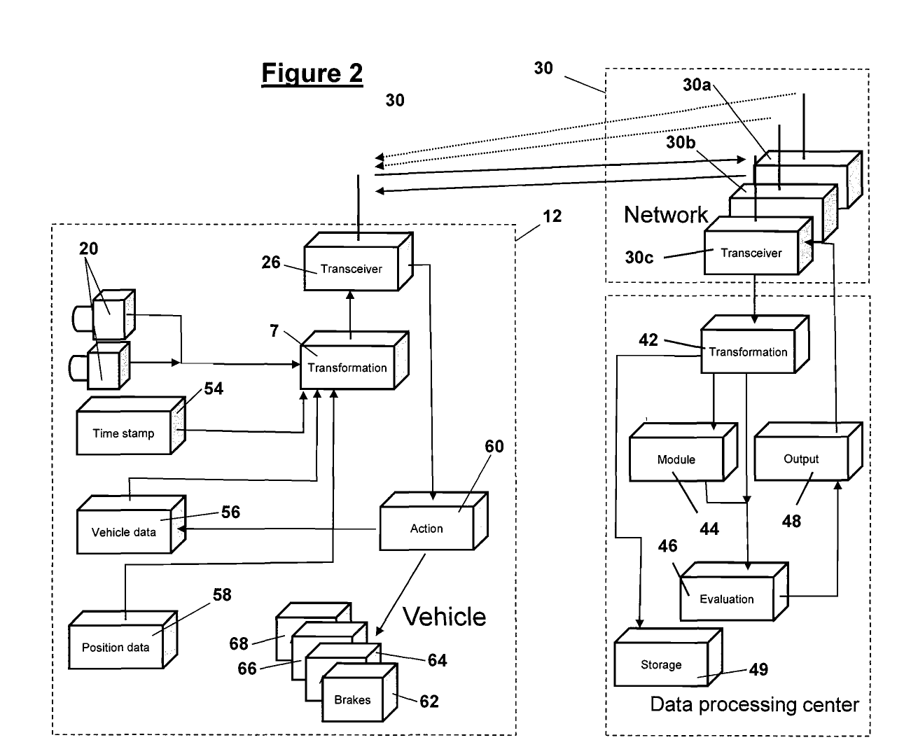

FIG. 2 shows a block diagram of a driver assistance system according to a second embodiment of the invention.

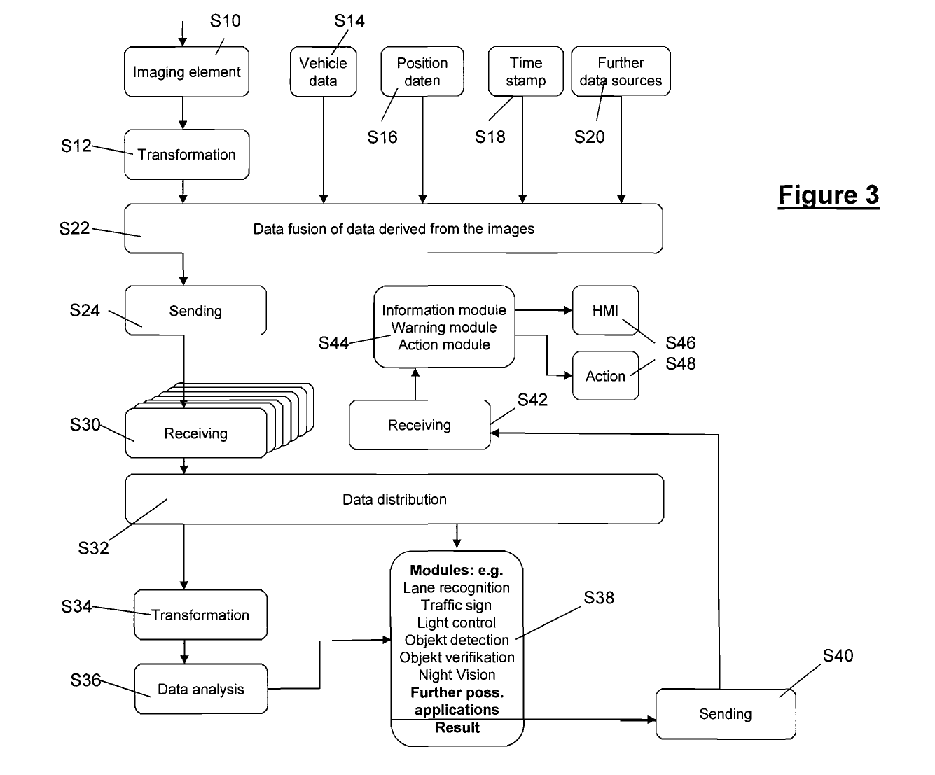

FIG. 3 shows a schematic illustration of the sequence of operations for data transmission of a driver assistance system according to the invention.

In FIG. 1, a schematic general view of a driver assistance system 10 according to a first embodiment of the invention is shown. A vehicle 12 located on a lane 14 of a road 16 has a camera 20 for capturing images of an area of the road 16 in front of the vehicle 12, which camera 20 is arranged on the inside of the windshield of the vehicle 12 between an interior mirror of the vehicle 12 and the windshield. The outer visual lines of the camera 20 are schematically illustrated by solid lines 22 and 24. The oval areas entered between the visual lines 22, 24 schematically indicate the detection area of the camera 20 at the respective distance. The vehicle 12 further has a sending/receiving unit 26 for sending image data generated with the aid of the camera 20. The image data are transmitted to a stationary sending/receiving unit 30a. Along the road 16, at suitable distances, further stationary sending and receiving units are arranged, of which the stationary sending/receiving units 30b and 30c are exemplarily illustrated in FIG. 1. The image data are preferably transmitted in a compressed form between the sending/receiving unit 26 of the vehicle 12 and the respective stationary sending/receiving unit 30a to 30c. The sending/receiving units 26, 30a to 30c are also referred to as transceivers.

The image data received by the stationary sending/receiving units 30a to 30c are transmitted to a stationary processing unit in a data processing center and are unzipped thereat preferably in a transformation module 42 of the stationary processing unit and supplied to various modules 44, 46 for the parallel and/or sequential generation of driver assistance functions. Here, by means of the modules 44, 46 representations of objects that are relevant for the driver assistance systems can be detected in the images, which are then classified and, if applicable, are tracked over several successively taken images. Based on the driver assistance information generated by means of the modules 44, 46, driver assistance data with the driver assistance information required for providing a driver assistance function in the vehicle are generated in an output module 48 and are transmitted to at least one stationary sending/receiving unit 30a to 30c that is located in the transmission range of the vehicle 12. The driver assistance data are then transmitted from this sending/receiving unit 30a to 30c to the vehicle 12. In the vehicle 12, a control unit (not illustrated) processes the driver assistance data and feeds the driver assistance information, dependent on the driver assistance function to be implemented, to a control unit for controlling a vehicle component, and/or outputs corresponding information on a display unit or via a loudspeaker to the driver of the vehicle 12.

In FIG. 2, a block diagram of a driver assistance system according to a second embodiment of the invention is shown. Elements having the same structure or the same function are identified with the same reference signs. In the second embodiment of the invention, the camera 20 of the vehicle 12 is designed as a stereo camera, wherein each of the single cameras of the camera system 20 generates one single image at the time of capture, the simultaneously captured images then being further processed as an image pair. The image data of the captured images are transmitted from the camera system 20 to a transformation module 52 that compresses the image data and adds further data with additional information. The image data in particular receive a time stamp generated by a time stamp module 54. The data with the additional information comprise in particular vehicle data such as the activation of a direction indicator, adjustments of the headlights, the activation of rear and brake lights, information on the activation of the brakes and further vehicle data which are preferably provided via a vehicle bus. Further, position data, are transmitted from a position determination module 58, which is preferably part of a navigation system of the vehicle 12, to the transformation module 52. The additional data, i.e. the time stamp, the vehicle data and the position data are transmitted as additional data together with the image data to the sending/receiving unit 26 of the vehicle and from there they are transmitted to the sending/receiving unit 30c via a radio data link to the communication network 30. From the sending/receiving unit 30c, the received data are transmitted to the data processing center 40. In contrast to the first embodiment of the invention, an additional storage element 49 is provided in the data processing center 40, in which storage element the image data can be intermediately stored. Preferably, the stored image data are deleted after a preset amount of time, for example, one day, unless a request is made to store the data permanently. This is in particular useful when images of an accident were captured by means of the vehicle camera 20, which images are to be stored for a later evaluation.

The evaluation of the transmitted image data and the generation of the driver assistance information as well as the transmission of the generated driver assistance information by way of respective driver assistance data to the sending/receiving unit 26 of the vehicle 12 takes place in the same manner as described in connection with FIG. 1. The received driver assistance data are fed to a control unit 60 which generates vehicle data corresponding to the driver assistance information for output via an output unit of the vehicle 12 and supplies them to the module 56. Additionally or alternatively, the control unit 60 can generate control data for vehicle modules, for example for the activation of the braking system 62, for the activation of the steering system 64, for the activation of the seatbelt tensioning drives 66 and for the activation of the headrest drives 68.

In FIG. 3, the sequence of operations for generating and transmitting data between the vehicle 12 and the stationary processing unit of the data processing center 40 is illustrated. In a step S10, the camera 20 generates image data which are compressed in a step S12. Parallel thereto, vehicle data are determined in a step S14, position data are determined in a step S16, the data for generating a time stamp are determined in a step S18, and the data of further data sources in the vehicle 12 are determined in a step S20. In a step S12, the compressed image data and the additional data determined in the steps S14 to S20 are transformed. When the image data are transformed in the step S12, a part of the image data generated by the camera 20 can be selected and prepared for transmission. The image data are transmitted together with the additional data in a step S24 from the sending/receiving unit 26 of the vehicle 12 to the stationary sending/receiving unit 30c which receives the transmitted data in a step S30. The received image data and preferably the transmitted additional data are then processed in a step S32 by the stationary processing unit 40, wherein the image data are unzipped in a step S34 and are analyzed together with the additional data in a step S36. The image data or, respectively, information determined from the image data as well as, if necessary, the transmitted additional information are supplied to modules for generating driver assistance information. In a step S38, these modules generate driver assistance information. The modules comprise in particular at least one module for lane recognition, for traffic sign recognition, for light control, for object detection, for object verification and for the so-called night vision in which by means of a respective projection onto the windshield objects that are badly visible are made more visible to the driver. Basically, modules for all known driver assistance system functions as well as for future driver assistance functions can be provided, which generate the respective driver assistance information required for the respective driver assistance function in the vehicle 12 in the step S38. Further, driver assistance data with the driver assistance information are generated, which are then transmitted by means of the stationary sending unit 30c to the sending/receiving unit 26 of the vehicle 12 in a step S40.

In a step S42, the sending/receiving unit 26 of the vehicle 12 receives the driver assistance data and feeds them to an information module, warning module and action module of the vehicle 12 that processes the driver assistance data in a step S44 and outputs corresponding information to the driver via a human-machine interface (HMI) in a step S46 as well as, additionally or alternatively, initiates an action of a vehicle component in a step S48 such as an activation of the braking system of the vehicle or of the steering system of the vehicle or of a safety device of the vehicle and/or of the light system of the vehicle.

It is particularly advantageous to design the vehicle components required for the described driver assistance system according to the invention as simply structured components which require little space and which, due to their relatively little space requirement, can easily be installed into new vehicles as well as can be retrofitted into existing vehicles. Also the updating of the modules for generating the required driver assistance information can easily be administered and updated centrally in the data processing center 40. As a result thereof, also easy access to these functions is possible as needed. Region-specific, in particular country-specific data, in particular for traffic sign recognition and for lane recognition can also be stored centrally in the stationary processing unit 40 and can be used for generating the driver assistance information dependent on the position of the vehicle 12.

For transmitting the image data from the vehicle 12 to the stationary receiving unit 30, known mobile radio networks, wireless radio networks such as wireless LAN or currently tested broadband data networks for the mobile radio field can be used. Alternatively or additionally, optical line-of-sight radio links can be used for transmitting the data between the vehicle 12 and the stationary receiving/sending unit 30c. As an alternative to the illustrated embodiment, each of the stationary sending/receiving units 30a to 30c can comprise a stationary processing unit 40 for processing the image data transmitted from the vehicle 12 or can be connected to such a processing unit 40.

By means of the invention, a space-saving design of the vehicle camera 20 and the sending/receiving unit 26 of the vehicle 12 is possible so that these can be used with a construction that is identical as far as possible in a large number of vehicles. These vehicle components 20, 26 can be used in an arbitrary country without a country-specific adaptation of software and/or hardware in the vehicle. The consideration of country-specific characteristics takes place by a selection or configuration of the software modules in the data processing center 40. There, an evaluation of representations of traffic signs, of lanes and of other objects takes place for object recognition. Based thereon, for example assistance in the light control and/or other currently known driver assistance functions can be provided. However, the system as indicated can likewise be easily extended to future applications. The transformation of the image information detected by means of the camera 20, which preferably is a transformation into compressed image data, is implemented by appropriate electronics, preferably a microprocessor, and these data are transmitted to the sending/receiving unit 26 which then sends these data, if applicable together with additional data, to the stationary sending/receiving unit 30a to 30c. In the data processing center 40, the driver assistance function is derived and evaluated dependent on modality. Based thereon, a driver assistance information is generated, which is transmitted in the form of data from the data processing center 40 to the stationary sending/receiving unit 30a to 30c and from there to the sending/receiving unit 26 of the vehicle 12. In the vehicle 12, at least one imaging sensor 20, i.e. at least one mono camera is provided. With the aid of the camera 20, preferably an area of the road in front of the vehicle 12 is captured. The driver assistance function generated with the aid of the generated driver assistance data can, in particular, comprise general information for the driver and/or a warning or action information. By evaluating the image information outside the vehicle 12, only relatively little resources are required in the vehicle 12 to provide a driver assistance function. Likewise, no or relatively little storage capacity is required in the vehicle 12 to store comparison data for classifying objects. By processing and evaluating the image data in the central data processing center 40, a country-dependent or, respectively, region-dependent image recognition can be implemented. Further, it is possible that the stationary processing unit 40 takes into account quickly changing road conditions such as changes in the direction of roads and roadworks, when generating the driver assistance information, and takes into account information transmitted by other vehicles when determining the driver assistance data. As already explained in connection with FIG. 2, the images transmitted to the stationary processing unit 40 can be stored at least for a limited amount of time by means of appropriate storage devices. In addition to the already mentioned accident documentation, the driver assistance information generated from the images can be checked with the aid of the stored images to, for example, attend to complaints of drivers about incorrect driver assistance information.

It is particularly advantageous that module updates and module extensions for generating the driver assistance information from the supplied image data can be carried out centrally in the data processing center 40. The driver assistance information generated from the transmitted image data in the data processing center 40 and/or the driver assistance information transmitted to the vehicle can be restricted dependent on the driver assistance functions, software licenses, and/or software modules enabled for the vehicle 12. Such an enabling can, for example, be based on a customer identification and/or a vehicle identification. The respective driver assistance function can also be spatially limited, for example, to one country. Thus, for example, a module Traffic Sign Recognition, Germany can be booked by a driver or customer, wherein then the data processing center 40 generates respective driver assistance information on the basis of the image data transmitted to the data processing center 40 and transmits them to the vehicle 12. Based on these functions, optical and/or acoustical information on the recognized traffic signs is output to the driver. Additionally or alternatively, the transmitted driver assistance information can be further processed, for example, fed to a system for generating a warning function in the case of speeding or fed to a cruise control for limiting the speed.

As vehicle cameras 20, both mono cameras and stereo cameras can be used, which capture color images or grayscale images. These cameras, in particular, comprise at least one CMOS sensor for capturing images or a CCD sensor for capturing images.

1. A data processing system for providing at least one driver assistance function, comprising at least one stationary receiving unit (30a to 30c) for receiving image data which have been generated by means of at least one image capturing unit (20) of a vehicle (12) by capturing at least one image of the surroundings of the vehicle (12), at least one stationary processing unit (40) for processing at least a part of the received image data, wherein the stationary processing unit (40) generates driver assistance data with at least one driver assistance information on the basis of the image data, wherein with the aid of the generated driver assistance information at least one driver assistance function can be generated in the vehicle (12), and at least one sending unit (30a to 30c) for sending the driver assistance data to the vehicle (12).

2. The data processing system according to claim 1, characterized in that an image capturing unit (20) of the vehicle (12) captures several images with a representation of an area of the surroundings of the vehicle (12) as an image sequence and generates image data corresponding to the representation for each captured image, and in that a vehicle sending unit (26) sends at least a part of the image data of the images to the stationary receiving unit (30a to 30c).

3. The data processing system according to one of the preceding claims, characterized in that a vehicle receiving unit (26) receives the driver assistance data sent by the stationary sending unit (30a to 30c).

4. The data processing system according to claim 3, characterized in that a processing unit arranged in the vehicle (12) processes the received driver assistance data and outputs information via a human-machine interface and/or controls at least one vehicle system of the vehicle (12).

5. The data processing system according to claim 4, characterized in that the vehicle system comprises a light system, a braking system, a steering system, a drive system and/or a warning system.

6. The data processing system according to one of the preceding claims, characterized in that the stationary processing unit (40) detects and classifies representations of objects in the images during processing of the received image data and generates the driver assistance data dependent on the classified objects.

7. The data processing system according to claim 6, characterized in that the stationary processing unit (40) determines the image position of a classified object and/or the relative position of the classified object to the vehicle (12) and/or the position of the classified object (12) in a vehicle-independent coordinate system.

8. The data processing system according to one of the preceding claims, characterized in that the image capturing system comprises at least one stereo camera (20), wherein the images of the single cameras of the stereo camera are transmitted as image data of an image pair from the vehicle sending unit (26) to the stationary receiving unit (30a to 30c).

9. The data processing system according to claim 8, characterized in that the stationary processing unit (40) determines the representations of the same object in the images of each image pair, determines their image position and determines the distance of the object to the stereo camera (20) on the basis of the image positions.

10. The data processing system according to one of the preceding claims, characterized in that the stationary receiving unit (30a to 30c) receives additional data with further information in addition to the image data from the vehicle (12).

11. The data processing system according to claim 10, characterized in that the further information comprises the current position of the vehicle (12), the speed, information on the weather conditions, information on the conditions of visibility, information on the settings and/or operating states of the vehicle (12) such as the adjusted light distribution of the headlights of the vehicle (12), and/or information detected by means of vehicle sensors such as detected lane markings, determined distances to objects, in particular to other vehicles.

12. A method for providing at least one driver assistance function, in which by means of a stationary receiving unit (30a to 30c) image data are received which have been generated by means of at least one image capturing unit (20) of a vehicle (12) by capturing at least one image of the surroundings of the vehicle (12), at least a part of the received image data is processed by means of a stationary processing unit (40), wherein, on the basis of the image data, driver assistance data with at least one driver assistance information are generated, with the aid of the generated driver assistance information at least one driver assistance function can be generated in the vehicle (12), and in which the driver assistance data are sent to the vehicle (12) by means of a sending unit (30a to 30c).
